(19) United States
(12) Patent Application Publication
(10) Pub. No.: US 2005/0174753 A1
(43) Pub. Date: Aug. 11, 2005

(54) Mining light

(76) Inventors: Densen Cao, Sandy, UT (US); Zhaohui Lin, Salt Lake City, UT (US); Hongyan Li, Sandy, UT (US); Lincoln Jolley, Herriman, UT (US)

Correspondence Address: Parsons Behle & Latimer;Suite 1800, 201 South Main Street, P.O. Box 45898, Salt Lake City, UT, 84111, US

(21) Appl. No.: 10/774,346

(22) Filed: Feb. 6, 2004

(51) Int. Cl. F21V 29/00

(52) U.S. Cl. 362/106; 362/294; 362/800; 362/802; 362/234

(57) ABSTRACT

A mining light having a semiconductor light source is disclosed. The light may include a semiconductor light source such as an LED or laser, a heat sink, a magnetic switch, a light reflective and focusing cone, and other features.

### BACKGROUND

In the field of underground mining, head lamps are needed that can last for the entire duration of a working shift without battery replacement. Some prior art underground mining head lamps utilized a head lamp on a miner's helmet connected by wire to an acid battery worn on a worker's belt. Such an arrangement was not only bulky and inconvenient, but it also lead to creating of sparks and flame, and is blamed by some as the cause of some mining fires. The leakage of acid from batteries may also result in personal injuries. Alternative tungsten light bulb mining lamps are undesirable because they suffer from a short lifetime.

### BRIEF DESCRIPTION OF THE DRAWINGS

FIG. 1 depicts an example mining helmet with an example mining light installed.

FIG. 2 depicts a cross sectional view of an example mining light.

FIG. 3 depicts an example assembly of battery packs and battery charger.

FIGS. 4, 5 and 6 depict example semiconductor light sources.

FIG. 7 depicts an example electrical connection block diagram.

### SUMMARY

A useful underground mining head lamp may be advantageous if it is compact, light weight, has a light source that has a long useful life, produces little heat, and does not create sparks or flame. Various structures and components of an underground mining head lamp featuring a semiconductor light source are disclosed. Those structures include a semiconductor light source, a light beam shaping system, a constant current control circuit, a magnetic switch, rechargeable battery pack, stripe to hold battery pack, and a battery charger to charge battery pack.

### DETAILED DESCRIPTION

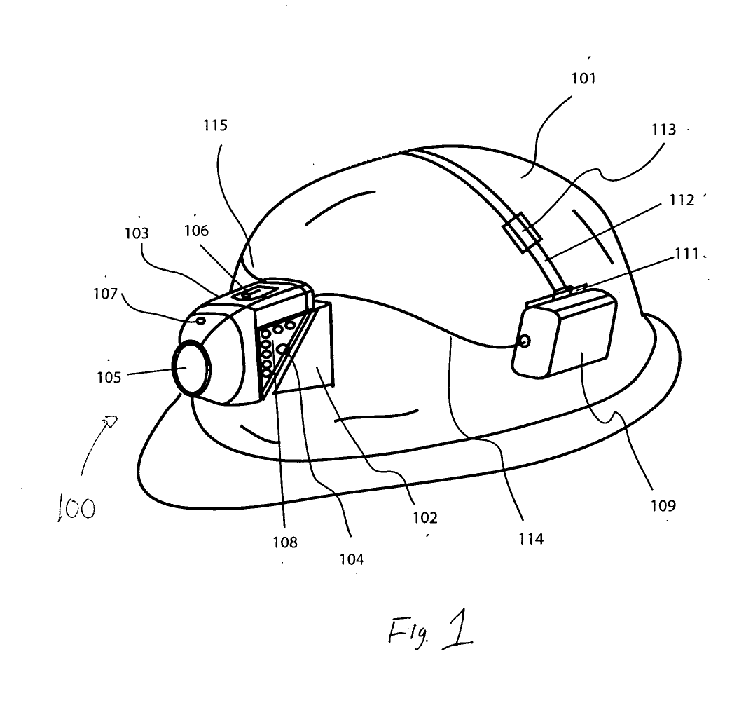

Referring to FIG. 1, an example underground mining lamp or light system 100 with battery operation is depicted on top a standard mining helmet 101. On the helmet, there is light head holder 102 formed or installed. The mining light has a body 103 for containing various components. A standard lamp clip 104 may be used to attach the mining light 100 to the holder 102. In the light head body 103, there is a light exit 105 through which a light beam emanating from the mining light 100 may travel.

A light switch 106 is used to turn the light on and off. The light switch 106 can include a magnetic button and a magnetic switch or another appropriate switch configuration. When the magnetic button is on top of the magnetic switch, the switch will conduct the current and the mining light will be ON. When the magnetic button is moved so that it is not on top of the magnetic switch, the switch will not conduct current and the mining light will be OFF. Using such an arrangement, the switching assembly can be made 100⁰% air tight, thereby eliminating the danger of sparks and fire. This is an important safety benefit that some mining lights can include.

An LED indicator 107 indicates battery energy level. When the battery energy level is below the required capacity to power the mining light, the LED indicator 107 will be lit to tell the user to charge the mining light battery.

A heat sink 108 is provided in the mining light to which a semiconductor light source may be attached or in heat conductance with. The semiconductor light source can emit visible light to create a light beam which miners will find useful. A flow of heat from the semiconductor light source to the heat sink is established so that the semiconductor light source does not overheat and lose brightness or suffer from a shortened life. The heat sink 108 may also used as a point of attachment for attaching the lamp clip 104. The lamp clip 104 would thus affix to both the heat sink 108 and the holder 102 to secure the mining light 100 to the helmet 101.

One or more battery packs 109 may be used to provide electrical power to semiconductor light source. For a longer duration of use, more than one battery pack may be needed, depending on mining light power usage. It is possible to locate the battery pack within the housing 103, but due to weight and balance considerations, a separate battery pack located remote from the semiconductor light source may be used. The battery pack may be light weight so that it can be attached to helmet 101 using a vego pad 111 or similar arrangement. The two battery packs on opposite sides of the helmet 101 can be held together by a strip 112 with a length adjustment mechanism 113. The electrical power from battery packs to the housing 103 may be transmitted using wires 114 and 115, such as sealed conduction wires. Such arrangement with a semiconductor light source at the front of the helmet and a battery pack on each side of the helmet may balance the helmet. Another balanced arrangement would include a semiconductor light source on the front of the helmet and a battery pack on the back of the helmet.

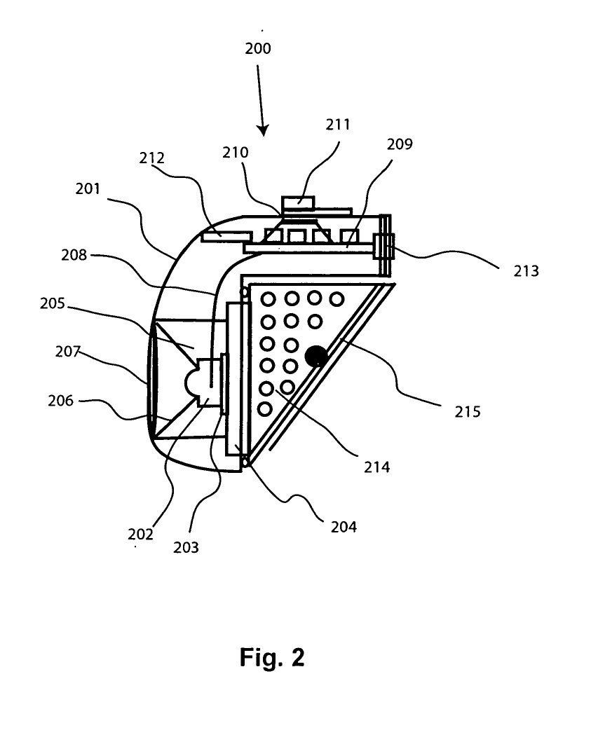

Referring to FIG. 2, a cross section of a light head 200 of an example mining light is depicted. In the light head 200, there is a casing 201, which can made of plastic, metal or other suitable materials. Inside the casing, there is a semiconductor light source 202 which can be attached directly or indirectly to a heat sink 204. The attachment can be achieved by any desired method, such as mechanical fixation, brazing or use of adhesive or epoxy. For example, as depicted, a heat conductive adhesive 203 attaches the semiconductor light source to the heat sink 204. There is a cavity 205 in the housing 201 in which the semiconductor light source may be located. A beam shaper or reflector or optical shape 206 may be used to gather light emitted by the semiconductor light source and shape it into a beam for exit through the cover or focus lens 207 and use by a miner in an underground mine. The cover or focus lens 207 can be flat optical glass, plastic or polycarbonate, an optical lens or part of reflector 206.

The semiconductor light source is electrically connected by conductive wire 208 to a control circuit 209. The control circuit provides the ability to energy from one or more batteries to the semiconductor light source via a constant current circuit so that the semiconductor light source will maintain a constant intensity light output.

On the example control circuit 209, there is magnetic switch 210. The magnetic switch has the ability to conduct electricity when a magnetic field is applied to it and cut off electricity when magnetic field is removed. A magnetic button 211 is placed outside of the casing or housing 201 provides the magnetic field for the magnetic switch. When the magnetic button is on top of the magnetic switch, the switch will conduct electricity and the light will be on and vice versa.

An indicator light 212 on the circuit board indicates battery status. When the indicator light is on, the user should recharge the battery.

A connector 213 may be provided along with the control circuit for battery connection. A dissipation heat sink 214 with geographic features to dissipate heat, such as fins, grooves, wings, holes or other physical features may be used. Thus, the semiconductor light source may be affixed to or in heat conductance with a secondary heat sink. The secondary heat sink in turn may be attached to or in heat conductance with a dissipation heat sink. This establishes a heat conductance path from the semiconductor light source to the secondary heat sink to the dissipation heat sink where heat is dissipated. Avoidance of heat buildup is important to avoid overheating the semiconductor light source and decreasing its light intensity output or decreasing its life. If desired, a semiconductor light source may be directly mounted to the dissipation heat sink. The dissipation heat sink may omit geographic features if desired. A clip 215 can be used to attach the heat sink 214 to a mining helmet.

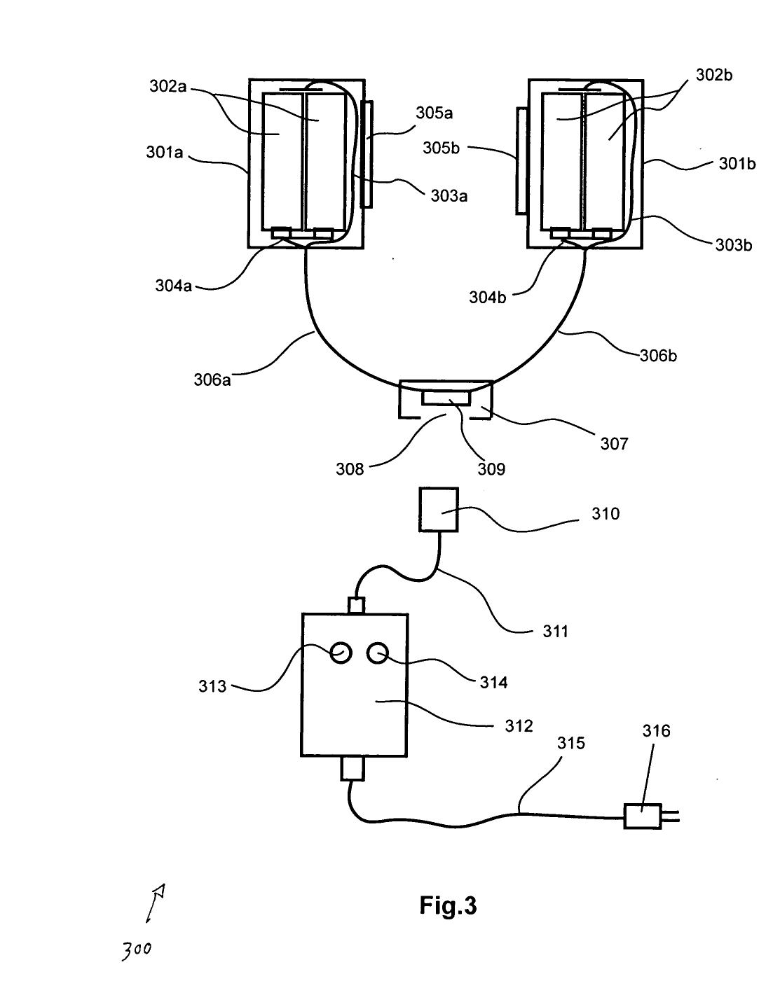

Referring to FIG. 3, an example the battery pack and charger are depicted 300. The battery packs provide the electrical power for the mining light to operate. The charger can be used to recharge the battery pack(s). Two battery packs are depicted but more or fewer could be used if desired. Rechargeable or disposable batteries may be used if desired. If disposable batteries are used, then the recharging function and hardware are unnecessary. Each battery pack has a casing 301a and 301b. Inside the casing, there are rechargeable or disposable batteries 302a and 302b. The batteries inside each casing are connected together through wires 303a, 304a, 303b, and 304b respectively. The batteries can be connected in either parallel, serial or a combination of such wiring. A vego pad 305a and 305b may be attached to each battery pack to use to mount the battery pack to a helmet. The battery pack output is through a cable 306a and 306b to a connector 307. The connector has opening 308 to mate with either a light head or a battery charger. There is a connection plug 309 in the connector 307 for making an electrical connection. In the battery charger, there is a plug 310 to fit to battery pack connector 307. A cable 311 connects the plug to a battery charge control 312. The control includes a charging circuit and two light indicators 313 and 314 respectively. One of the light indicators indicates that the battery is being charged and the other indicates that the battery is completely charged and ready for use. The charger control is connected to an AC power source such as a wall outlet through a cable 315 and a plug 316.

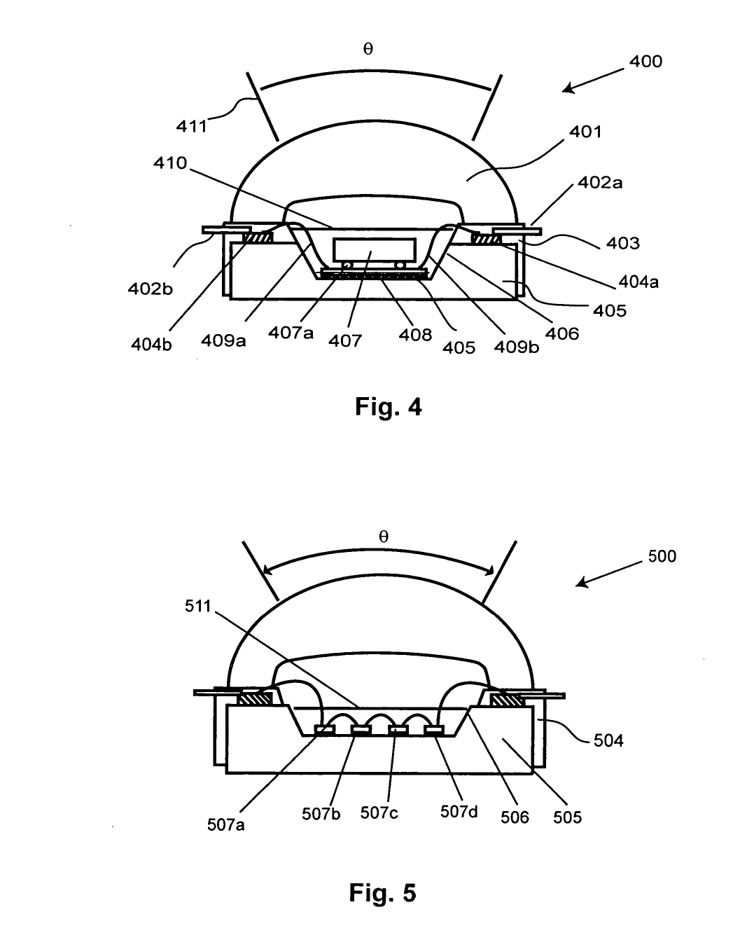

FIGS. 4, 5 and 6 depict example semiconductor light sources that may be used in the mining light. Other semiconductor light sources can be used as desired. FIG. 4 depicts a side view of an LED module 400 according to a flip-chip design that can serve as a semiconductor light source. The light source 400 includes a cover or dome 401 that serves to protect the LED(s) within from contamination from moisture and dirt and from mechanical damage. The dome 401 may also serve to focus light emitted by the LED. A light emitting diode chip array 407 is mounted in inverted position in a well 406 of a primary heat sink 405 according to the so-called “flip chip” design. In this example, the chip has an insulative substrate. The chip 407 is mounted on a flip chip pad 408 within a well 406 of the primary heat sink 405. Electrode beads or bumps 407a and 407b separate the chip from the pad but attach the chip to the pad and provide electrical connection. The pad is affixed to the bottom of the well by a method such as soldering, brazing, welding or use of a heat-conductive or light reflective adhesive 405. The chip has an electrode on top and its epitaxial layers (semiconductor material) facing down toward the pad and the bottom of the well in the figure. The pad upper surface may be light reflective so that light is reflected from the pad in a useful direction. The pad may be coated with a light reflective film, such as Au, AI or Ag. The heat sink maybe surrounded by an insulative jacket 403. The chip is powered via wires 409a and 409b attached to intermediate islands 404a and 404b. The chip is covered by a wavelength shifting coating or layer 410 which serves to shift the wavelength of light emitted by the light to a desired wavelength. For example, if a blue LED chip is used, then a yellow phosphor coating could be applied to produce a combination of yellow and blue light which will be seen by the human eye as white light. Light from the light source is emitted as a beam 411 having an angle of departure θ that is defined and determined in part by the angle of the walls of the well as well as by any focusing or restrictive characteristics of the dome. In such a package, all of the light emitted from the chip can be reflected back in the light exit direction for highest light output. The well may also include a reflective coating or polished surface.

FIG. 5 depicts an LED module 400 that includes a well 506 within a primary heat sink 505 and having a plurality or array of LED chips 507a, 507b, 507c within the well. The depth of the well can be from 0 mm to more than 50 mm. Each individual LED chip may include semiconductor material or epitaxial layers on a substrate. Each chip may be mounted to the heat sink by use of heat conductive or light reflective adhesive or other mounting means. The chips in this figure are wired in series, although wiring in parallel is also possible when the application requires it. A wavelength shifting coating 511 may be included to shift the light emitted by the chips from monochromatic light to white light visible to human eyes.

FIG. 6 depicts a semiconductor light emitting module 600 that has a single LED or laser chip 607 mounted in a well 606 of a primary heat sink 605. The chip 607 has a conductive substrate and may be mounted to the floor of the well of the heat sink by use of a heat conductive or light reflective adhesive. The chip is powered by wire 609 from island 603. A negative electrode 602b is provided at the base of the primary heat sink. A wire lead 602a brings electrical power to the module. An insulative jacket 604 may be placed around the heat sink for electrical insulation. The chip 607 may be mounted by appropriate means such as a layer of heat conductive and light reflective adhesive 608 in the bottom of the well 606. A wavelength shifting coating 610 may be provided. The chip 607 may be a chip of large surface area, such as for example a size of more than about a×b where a is at least 0.3 mm and b is at least 0.3 mm. Such chips include vertical cavity surface emitting lasers, LED chips, and LED chip array. The light emitting module in FIG. 6 can be single chip or multiple chips.

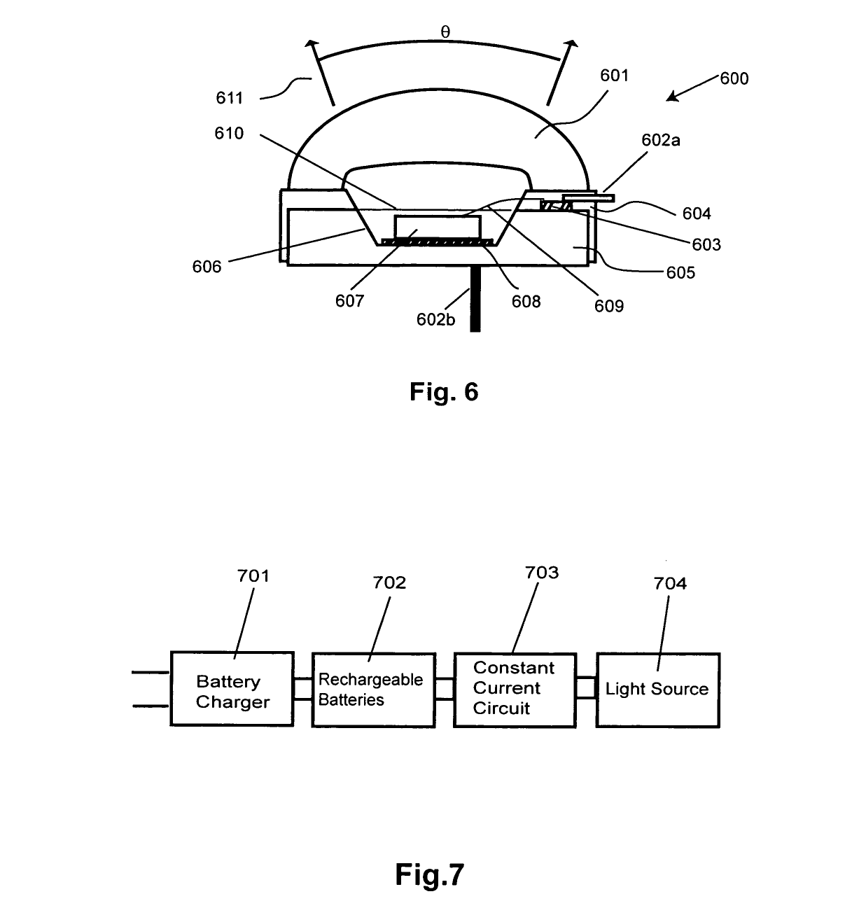

FIG. 7 depicts a block diagram of circuitry used in a mining light. It may include a battery charger 701, rechargeable batteries 702, a constant current circuit 703, and a light source 704. Other configurations are possible as desired.

For light sources with multiple semiconductor light producing chips, the number of chips used may vary depending on application, and can range from 1 to several hundred. The spacing between chips can be adjusted from zero to more than 1 mm, depending on the application requirements. The semiconductor chip producing light may be a single chip or single chip array. The chip or chips may be mounted in a well of a heat sink or may be mounted directly on a heat sink. The wavelength of light emitted from each chip in a multi-chip light design may be the same wavelength or different wavelengths to cover a desired light spectral range. If a well is provided in the heat sink, the depth of the well may be as desired, such as from 0 to 50 mm or more, depending on application.

The light source maybe constructed with the chip(s) mounted to the primary heat sink, such as by use of a heat conductive and/or light reflective adhesive. The primary heat sink can be attached to a secondary heat sink if desired, such as; by use of a heat conductive and/or electrically insulative adhesive, welding, brazing, soldering or mechanical fixation.

The chip(s) maybe any of those described herein or otherwise, such as a flip chip design. The primary heat sink, chip(s) and dome can be combined as a light module. A cover may be provided over the dome. An example cover would include a plastic fitting or attachment and a glass window through which light may travel. Glass generally has better light transmission qualities than plastic, but either could be used. The dome can serve as a focusing lens.

A reflective cone may be included in the light, such as between the dome and the light exit or aperture from which light exits the light. The cone can be used for a light conservation purpose, to capture and use light that would be errant and would otherwise be wasted. The cone can also be used for the purpose of beam shaping and to create a light beam with a desired footprint. Example light beam footprints include circular, oval, square, rectangular, and any other geometric shape, depending on application. The footprint can be any desired size for the application. A shaped beam can have superior light intensity. The reflective cone can have an interior surface that reflects light. Some cones may reflect at least as much as 85% of the light that encounters them. Materials of cones can be plastic or metal, polished or plated metal such as aluminum or alloy, or otherwise. Use of a cone allows superior maintenance of light beam intensity as distance from the chip(s) increases.

The heat sinks in the mining lgiht may be any material capable of conducting heat away from the semiconductor light sources. The heat sink(s) may be of a single material or a combination of two different kinds of materials, the first with a low thermal expansion rate and the second with high thermal conductivity. Monolithic heat sinks may be used as well. Examples of some heat sink materials which may be used in lights depicted herein include ceramic, powdered metal, copper, aluminum, silver, magnesium, steel, silicon carbide, boron nitride, tungsten, molybdenum, cobalt, chrome, Si, SiO₂, SiC, AlSi, AlSiC, natural diamond, monocrystalline diamond, polycrystalline diamond, polycrystalline diamond compacts, diamond deposited through chemical vapor deposition and diamond deposited through physical vapor deposition, and composite materials or compounds. Any materials with adequate heat conductance and/or dissipation properties can be used.

Mounting of any semiconductor chip or light module or semiconductor light source may be achieved by a variety of methods, including mechanical fixation (clips, press-fit, screws, rivets, etc.), brazing, welding, use of an adhesive or other methods. Use of a heat conductive and/or electrically insulative adhesive may be desired. Examples of heat conductive and/or electrically insulative adhesives which may be used are silver based epoxy, other epoxies, and other adhesives with a heat conductive quality and/or electrically insulative quality. In order to perform a heat conductive function, it is important that the adhesive possess the following characteristics: (i) strong bonding between the materials being bonded, (ii) adequate heat conductance, (iii) electrically insulative or electrically conductive if desired (or both), and (iv) light reflectivity if desired, or any combination of the above. Examples of light reflective adhesives which may be used include silver and aluminum based epoxy. One example heat conductive and electrically insulative adhesive includes a mixture of a primer and an activator. In this example, the primer may contain one or more heat conductive agents such as aluminum oxide (about 20-60%) and/or aluminum hydroxide (about 15-50%). The primer may also contain one or more bonding agents such as polyurethane methacrylate (about 8-15%), and/or hydroxyalkyl methacrylate (about 8-15%). An activator may be mixed with the primer to form an adhesive. The activator may include any desired catalyst, for example n-heptane (about 5-50%), aldheyde-aniline condensate (about 30-35%), isopropyl alcohol (about 15-20%), and an organocopper compound (about 0.01 to 0.1%). Adhesives such as described herein can be used to mount a chip to a primary heat sink, or to mount a primary heat sink to a secondary heat sink, or both.

The semiconductor light sources can include semiconductor chips that emit light when provided with electrical power. The chips may include any of a variety of materials known for constructing chips that emit light. The chips may include a variety of epitaxial layers grown on a substrate. Examples of substrates on which the semiconductors used in the lights depicted herein may be grown include Si, GaAs, GaN, ZnS, ZnSe, InP, Al₂O₃, SiC, GaSb, InAs and others. Both electrically insulative and electrically conductive substrates may be used.

If desired, any of the heat sinks of the backlight may include a thermoelectric cooler on them to enhance cooling. A thermoelectric cooler tends to provide a cooling effect when electrically charged, thereby assisting in keeping the light cool, preventing overheating of semiconductors which may decrease their efficiency or life, and prevents the backlight from becoming hot enough to danger its surrounding environment. Example materials which may be used in a thermoelectric cooler in backlights include Bi₂Te₃, PbTe, SiGe, BeO₂, BiTeSe, BiTeSb, AlO₃, AlN, BaN and others.

The primary heat sink is typically either of lesser mass or lesser interior volume or both than the primary heat sink. A cover may be provided that covers the semiconductor light sources if desired.

Epitaxial layers and structures of semiconductor light emitting chips useful in lights disclosed herein may include a substrate (such as sapphire) that serves as a carrier pad or platform on which to grow the chip's epitaxial layers. The first layer placed on the substrate may be a buffer layer (such as a GaN buffer layer). Use of a buffer layer reduces defects in the chip that would otherwise arise due to differences in material properties between the epitaxial layers and the substrate. Then a contact layer, such as n-GaN, may be provided. A cladding layer such as n-AIGaN Sub may be present to confine injected electrons. An active layer may be provided to emit the light when excited by electrons. An example active layer is such as AGaN with multiple quantum wells. The active layer is where electrons jump from a conduction band to valance and emit energy which converts to light. On the active layer, another cladding layer may be provided, such as p-AIGaN, to serve to confine electrons. A contact layer such as p+ GaN may be provided that is doped for Ohmic contact. The contact layer may have an electrode mounted on it.

The physical dimension of the chip(s), including their surface area, used in the light can impact the intensity of the light produced. The chips could be of any desired size and shape, and might range from a surface area of more than about 300 um. Each individual chip may have a power output more than about 20 mW. The chips may emit light of any desired wavelength, including light from wavelengths ranging from 200 to 1500 nm.

Some examples of semiconductor light sources which maybe desired to be used in a light include light emitting diode chips, LED chip arrays (an LED chip with a large surface area and having paths of electrically conductive material projecting across some portions of its surface to power the chip), laser diodes, vertical cavity surface emitting lasers (VCSEL), VCSEL arrays, edge emitting lasers, surface emitting lasers, photon recycling devices that cause a monochromatic chip to emit white light, and others, in any desired configuration. Direct mount, surface mount, flip chip and any other desired chip mounting configuration may be employed.

Heat sinks used in the lights can be of a variety of shapes and dimensions, such as those depicted in the drawings or any others which are useful for the structure of the particular light source being constructed. It should be noted that the heat sink arrangement should be sufficient to prevent overheating of the semiconductor light source, or diminished light production and shortened product life may result.

While the present lights have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations of lights described herein are to be considered in all respects as only illustrative, and not restrictive. All changes that come within the meaning and range of equivalency of the claims are to be embraced within their scope.

1. A mining light comprising:
a light module, the light module including
a semiconductor chip capable of emitting generally monochromatic light,
a wavelength shifting coating on said chip for converting generally monochromatic light emitted by said semiconductor chip to white light,
a primary heat sink to which said semiconductor chip is attached,
a secondary heat sink to which said primary heat sink is directly or indirectly attached, said primary heat sink and said secondary heat sink being in heat conductance with each other,
a dissipation heat sink having geographical features to aid in heat dissipation, said secondary heat sink being in heat conductance with said dissipation heat sink,
a heat conductance path originating at said semiconductor chip where heat is produced by said chip when it is powered and emitting light, said heat conductance path thence to said primary heat sink, thence to said secondary heat sink and thence to said dissipating heat sink,
said secondary heat sink having a greater internal volume than said primary heat sink,
a remote battery pack, said battery pack and said light module being physically separate for mounting in separate locations on a mining helmet,
said remote battery pack being in electrical communication with said light module so that said remote battery pack may provide electrical power for powering operation of the mining light.

2. A device as recited in claim 1 wherein said light module further comprises:
a magnetic switch that utilizes a magnetic field to initiate and terminate electrical connection of the light module to a battery pack, said magnetic switch being airtight.

3. A device as recited in claim 1 further comprising second remote battery pack.

4. A device as recited in claim 3 further comprising a strap for securing said battery packs on opposite sides of a mining helmet.

5. A device as recited in claim 1 further comprising light reflective adhesive between said semiconductor chip and said primary heat sink.

6. A device as recited in claim 1 further comprising heat conductive adhesive between said primary and said secondary heat sinks.

7. A device as recited in claim 1 further comprising a light reflector in said light module, said light reflector serving to gather light emitted by said semiconductor chip and reflecting it as a useful light beam.

8. A device as recited in claim 1 wherein said semiconductor chip is selected from the group consisting of light emitting diode chips, LED chip arrays, laser diodes, vertical cavity surface emitting lasers, VCSEL arrays, edge emitting lasers, surface emitting lasers and photon recycling devices.

9. A device as recited in claim 1 wherein at least one of said heat sinks includes a material selected from the group consisting of copper, aluminum, silver, magnesium, steel, silicon carbide, boron nitride, tungsten, molybdenum, cobalt, chrome, Si, SiO₂, SiC, AISi, AISiC, and diamond.

10. A device as recited in claim 1 wherein said chip includes epitaxial layers located on a substrate and wherein said substrate is selected from the group consisting of Si, GaAs, GaN, ZnS, ZnSe, InP, AI₂O₃, SiC, GaSb, and InAs.

11. A device as recited in claim 1 wherein said semiconductor chip includes epitaxial layers located on a substrate.

12. A mining light comprising:
a light module, the light module including
a semiconductor chip capable of emitting generally monochromatic light,
a wavelength shifting coating for converting generally monochromatic light emitted by said semiconductor chip to white light,
a primary heat sink to which said semiconductor chip is attached,
a secondary heat sink to which said primary heat sink is directly or indirectly attached, said primary heat sink and said secondary heat sink being in heat conductance with each other, and
a magnetic switch that utilizes a magnetic field to initiate and terminate electrical connection of the light module to a battery pack in order to initiate and terminate light emission from the mining light, said magnetic switch being airtight, and
a remote battery pack, said battery pack and said light module being physically separate for mounting in separate locations on a mining helmet,
said remote battery pack being in electrical communication with said light module so that said remote battery pack may provide electrical power for powering operation of the mining light.

13. A device as recited in claim 12 further comprising second remote battery pack and a strap for securing said battery packs on opposite sides of a mining helmet.

14. A device as recited in claim 12 further comprising light reflective adhesive between said semiconductor chip and said primary heat sink.

15. A device as recited in claim 12 further comprising heat conductive adhesive between said primary and said secondary heat sinks.

16. A device as recited in claim 12 further comprising a dissipation heat sink and a heat conductance path going from said chip to said primary heat sink to said secondary heat sink and finally to said dissipation heat sink where heat created by said chip is dissipated.

17. A device as recited in claim 12 further comprising a light reflector in said light module, said light reflector serving to gather light emitted by said semiconductor chip and reflecting it as a useful light beam.

18. A device as recited in claim 12 wherein said semiconductor chip is selected from the group consisting of light emitting diode chips, LED chip arrays, laser diodes, vertical cavity surface emitting lasers, VCSEL arrays, edge emitting lasers, surface emitting lasers and photon recycling devices.

19. A device as recited in claim 12 wherein at least one of said heat sinks includes a material selected from the group consisting of copper, aluminum, silver, magnesium, steel, silicon carbide, boron nitride, tungsten, molybdenum, cobalt, chrome, Si, SiO₂, SiC, AISi, AISiC, and diamond.

20. A device as recited in claim 12 wherein said chip includes epitaxial layers located on a substrate and wherein said substrate is selected from the group consisting of Si, GaAs, GaN, ZnS, ZnSe, InP, Al₂O₃, SiC, GaSb, and InAs.

21. A device as recited in claim 12 wherein said semiconductor chip includes epitaxial layers located on a substrate.

22. A mining light comprising:
a light module, the light module including
a semiconductor chip capable of emitting light when electrically powered,
a primary heat sink to which said semiconductor chip is attached,
a secondary heat sink to which said primary heat sink is directly or indirectly attached, said primary heat sink and said secondary heat sink being in heat conductance with each other, and
a magnetic switch that utilizes a magnetic field to initiate and terminate electrical connection of the light module to a battery pack, said magnetic switch being airtight, and
a battery pack, said battery pack being in electrical communication with said light module so that said remote battery pack may provide electrical power for powering operation of the mining light.

23. A mining light comprising:
a semiconductor chip capable of emitting light,
a heat sink for dissipating heat created by said chip, and
a magnetic switch that utilizes a magnetic field to initiate and terminate electrical connection of the light module to a battery in order to initiate and terminate light emission from the mining light, said magnetic switch being airtight.

24. A mining light comprising:
a semiconductor chip capable of emitting light,
a heat sink for dissipating heat created by said chip,
a reflector for gathering light emitted by said chip and reflecting it as a light beam, and
a magnetic switch that utilizes a magnetic field to initiate and terminate electrical connection of the light module to a battery in order to initiate and terminate light emission from the mining light, said magnetic switch being airtight.
